(19) United States
(12) Patent Application Publication
(10) Pub. No.: US 2004/0253287 A1
(43) Pub. Date: Dec. 16, 2004

(54) Environmentally safe insecticides

(76) Inventor: Robert Michael Denton, Delray Beach, FL (US)

Correspondence Address: STOCKWELL & ASSOCIATES, PSC, 861 CORPORATE DRIVE, SUITE 201, LEXINGTON, KY, 40503, US

(21) Appl. No.: 10/633,017

(22) Filed: Aug. 2, 2003

Related U.S. Application Data
(60) Provisional application No. 60/400,732, filed on Aug. 3, 2002.

(51) Int. Cl. A01N 25/00; A01N 37/02

(52) U.S. Cl. 424/405; 514/546

(57) ABSTRACT

An environmentally safe insecticide and its method of use are disclosed. The inventive insecticide comprises an effective concentration of an alkyl ester of lactic acid. Ethyl lactate is a preferred alkyl ester of lactic acid. Reduction in insect infestation is achieved by applying the insecticide of the invention to an infested substrate. Typical substrates include plants, crops, trees, animals, and humans, and surfaces that come into contact with plants, crops, trees, animals, and humans.

### CROSS-REFERENCE TO RELATED APPLICATIONS

This application claims priority from provisional application Ser. No. 60/400,732 filed Aug. 3, 2002.

### FIELD OF THE INVENTION

This invention relates to insecticides and, more particularly, to such compositions which are highly effective in killing insects while also being non-toxic to humans, animals, and the environment.

### BACKGROUND ART

Substantial effort has been expended to develop effective insecticides, which are capable of eradicating or controlling insects which destroy ornamental and agricultural plants, crops, trees, etc. or which attack, harm, or annoy humans and animals. Insect, as used herein, is used informally, in that it refers not only to members of the phylogenetic Class Insecta, but also to the various similar arthropod animals, such as spiders, centipedes, mites and ticks. Similarly, insecticide, as used herein, refers to chemicals which eradicate insects, spiders, mites, ticks, etc. Despite the substantial need for products which control or eradicate these insects, there is a scarcity of effective formulations which are capable of eradicating insects, while also being non-toxic to humans and animals.

There are a wide variety of pesticides and insecticides in the prior art. However, these prior art formulations typically include active ingredients which are highly toxic to humans and/or animals. Consequently, the prior art formulations must be used at low concentrations, which decreases toxic effects, but also decreases potency.

Another problem with prior art insecticides is that insects frequently develop resistance or immunity to the insecticide. Due to the highly adaptive nature of most insects and the manner in which insecticides typically function, many prior art insecticides are effective initially, but lose their effectiveness over time. The development of new insecticides helps to address this problem by providing alternate insecticides, which can be used in combination or in an alternation with other insecticides.

Historically, one of the best known insecticides is dichlorodiphenyltrichlorocthane (DDT). Although DDT was found to have extraordinary insecticidal properties and had been widely used as one of the most effective insecticides, its use has now been banned in the United States and in other countries due to its more recently discovered toxicity to humans and animals.

Subsequent to the banning of DDT, numerous other organochlorides were developed as pesticides. Organophosphate compounds were also found to be highly effective. However, these compounds were also discovered to have deleterious effects on the environment.

Pyrethroids or pyrethrins have also been employed as insecticides in the prior art. However, many insects have developed resistance or immunity to the insecticidal effect of the pyrethroids and, as a result, these compounds are ineffective for controlling insects.

Most prior art insecticides are non-biodegradable, causing the insecticide to continuously build up in the soil and, subsequently, in the food chain. This long-term build up has been found to be particularly hazardous to the long-term health a variety of animal populations. As a result, use of many such insecticides has been either banned or severely restricted by recent legislation.

Although the need for an effective, non-toxic, biodegradable insecticide has existed for decades, an effective insecticide has not been realized. As an alternative, nonchemical methods have been used. However, little success has been attained with nonchemical methods. As a result, in addition to these nonchemical methods, insecticides continue to be used in limited concentrations with reduced efficacy.

Therefore, it is a principal object of the present invention to provide an effective insecticide which eradicates insects which attack or feed on plants, crops, trees, animals, and humans without harming the plants, crops, trees, animals, or humans coming in contact with the insecticide.

Another object of the present invention is to provide an insecticide which is non-toxic to humans, animals, and the environment. Thus, the insecticide is safe to use and avoids common deleterious side effects of past insecticides.

Another object of the present invention is to provide an insecticide having the characteristic features described above which is completely biodegradable and completely safe for application directly to desired plants, humans and animals.

A further object of the present invention is to provide an insecticide having the characteristic features described above which is not harsh or irritating to the skin of humans and animals and can be safely applied, without harm, to skin, scalp, or hair.

Another object of the present invention is to provide an insecticide having the characteristic features described above which can be employed as an insecticide without harmful side effects to the user.

Another object of the present invention is to provide an insecticide having the characteristic features described above which has no adverse effects on the food products produced by treated plants, crops, and trees, as well as no adverse effect on the soil or water.

Other and more specific objects will in part be obvious and will in part appear hereinafter.

### DETAILED DESCRIPTION

By employing the present invention, all of the prior art difficulties and drawbacks are completely eliminated and a safe, effective insecticide is attained. As detailed herein, the compositions of the present invention are particularly constructed for controlling insects and other arthropods.

The present invention provides safe and highly effective insecticides, while also providing compositions which are non-toxic to humans, animals, and the environment. The compositions of this invention are non-toxic, which causes no harm or injury to humans, animals, and fully biodegradable, which causes no harm to the environment, water systems.

The chemical formulations of the present invention comprise compositions which include alkyl lactates, such as ethyl lactate. Although the alkyl lactates employed in the compositions of the present invention are generally well known and have been widely used, their efficacy as insecticides has been heretofore unrecognized in the prior art.

By employing the compositions of the present invention, insecticides and insect repellents are attained which are highly effective in controlling insects that are harmful to plants, trees, crops, humans, and animals. In particular, the formulations of the present invention may function as contact sprays capable of killing insects on contact, as well as lotions and shampoos for direct application to skin or hair.

The insecticide compositions of the present invention are safely employed on humans, animals, plants, trees, crops, fruit trees and the like, as well as functioning as an effective general household product. One of the particular unique aspects of the compositions of the present invention is the ability of these compositions to function as highly effective insecticides, while also being completely biodegradable and non-toxic to humans, animals and the environment, particularly the water systems.

Another unique aspect of the insecticide compositions of the present invention is the attainment of a highly effective and efficient insecticide which employs alkyl lactates commonly employed in cosmetic products and in foods as additives. By employing alkyl lactates, the non-toxic safety of the resulting compositions is apparent and the ability to employ these compositions without in any way harming humans, animals, or the environment is readily apparent.

Although the alkyl lactates in the insecticide compositions of the present invention are commonly employed in cosmetics and foods, the use of these compounds as an insecticide represents a unique and unobvious departure from prior art teachings. There is no teaching or suggestion in the prior art that these products can be employed or combined in the manner detailed herein to attain the highly effective insecticide compositions achieved by the present invention.

In accordance with the teaching of the present invention, the compositions of the invention comprise alkyl lactates wherein the alkyl group has 1 to 12 carbon atoms. As fully detailed herein, by employing these compositions, highly effective insecticides are attained which completely eliminate all of the drawbacks of the prior art. In addition, the insecticide compositions of the present invention are non-toxic to humans, animals, and the environment, enabling the insecticides to be freely used without adverse consequences.

Specific examples of the alkyl lactate group, include a methyl group, an ethyl group, a propyl group, a butyl group and the like, preferably an ethyl lactate group.

According to one preferred embodiment of the present invention, the environmental surface disinfectant contains ethyl lactate as the insecticide ingredient. Insecticide activity of the composition is attained at concentrations of ethyl lactate greater than two per cent, achieving maximal activity at ethyl lactate concentrations of approximately fifty percent. Accordingly, the preferred concentration range for ethyl lactate when employed in the insecticide compositions is between two and fifty percent.

### EXAMPLE

The following example shows one preferred embodiment according to the invention. The components and specific ingredients are presented as being typical, and various modifications can be derived in view of the foregoing disclosure within the scope of the invention. A stock formulation is prepared as in Table 1.

TABLE 1

| Ingredient | Weight % |
|---|---|
| Ethyl Lactate | 16.0% |
| Fragrance | 1.0% |
| Water | 83.0% |

Fragrance is added to the ethyl lactate and then mixed into the water. However, no particular order needs to be followed.

The efficacy of dilutions of the stock formulation in Table 1 was tested on dust mites Dermatophagoides farinae. For each sample, approximately twenty (20) dust mites were placed in a petri dish containing media dyed with Sudan red. Dust mites were allowed to feed on the media for two days. The dust mites fed in this manner take on a reddish hue, allowing them to be easily visualized. Absorbent fabric was placed on the bottom of the petri dishes. The fabric was moistened with deionized water or dilutions of the stock formulation in equivalent volumes, and the petri dishes were covered with Fluon®. Three replicates were performed for each dilution. Dust mite mortality was recorded after twenty four (24) hours.

Turning to Table 2, there is shown that dilutions of the formulation in Table 1 exhibit a high insecticidal efficiency.

TABLE 2

| Dilution | |
|---|---|
| (deionized | |
| water: stock | Average |
| formulation) | Mortality |
| 1:0 | 7% |
| 3:1 | 100% |
| 5:1 | 100% |

Due to the gentle, non-toxic nature of the stock formulation, the composition may be applied directly to the skin or hair of humans or animals without any adverse reactions. In order to effectively apply the insecticide compositions defined in Table 1, the compositions can be formed as a lotion, spray, or shampoo.

The insecticide formulation may include water, fragrances, surfactants, disinfectants, detergents or a combination thereof.

It should be recognized that embodiment described herein is merely illustrative and is not meant to be limiting. Alternative embodiments are possible without departing from the scope of the present invention.

What is claimed is:

1. An insecticide or comprising at least one alkyl ester of lactic acid wherein the alkyl group of said alkyl ester has 1 to 12 carbon atoms.

2. The composition of claim 1 wherein the alkyl group concentration is between about 2% and about 50% by volume.

3. The composition of claim 2 wherein the alkyl ester of lactic acid is methyl lactate.

4. The composition of claim 2 wherein the alkyl ester of lactic acid is butyl lactate.

5. The composition of claim 2 wherein the alkyl ester of lactic acid is propyl lactate.

6. The composition of claim 2 wherein the alkyl ester of lactic acid is ethyl lactate.

7. The composition of claim 1 further comprising a composition selected from the group comprising water, fragrances, surfactants, disinfectants, detergents or a combination thereof.

8. The composition of claim 3 further comprising a composition selected from the group comprising water, fragrances, surfactants, disinfectants, detergents or a combination thereof.

9. The composition of claim 4 further comprising a composition selected from the group comprising water, fragrances, surfactants, disinfectants, detergents or a combination thereof.

10. The composition of claim 5 further comprising a composition selected from the group comprising water, fragrances, surfactants, disinfectants, detergents or a combination thereof.

11. The composition of claim 6 further comprising a composition selected from the group comprising water, fragrances, surfactants, disinfectants, detergents or a combination thereof.

12. A method of reducing insect infestation on a substrate, comprising applying the composition of at least one alkyl ester of lactic acid wherein the alkyl group of said alkyl ester has 1 to 12 carbons to the substrate.

13. The method of claim 12 wherein said substrate is selected from the group comprising a plant, a crop, a tree, an animal, or a human, or a surface which may contact a plant, a crop, a tree, an animal or a human.

14. The method of claim 13 wherein said composition is applied to the skin, scalp, or hair of said human.

15. The method of claim 12 wherein said composition is applied to said substrate through a process selected from the group comprising dipping the substrate in said composition, spraying said composition on said substrate or wiping said composition on said substrate.

16. The method of reducing insect infestation on a substrate comprising applying the composition of claim 7 to the substrate.

17. The method of reducing insect infestation on a substrate comprising applying the composition of claim 8 to the substrate.

18. The method of reducing insect infestation on a substrate comprising applying the composition of claim 9 to the substrate.

19. The method of reducing insect infestation on a substrate comprising applying the insecticidal composition of claim 10 to the substrate.

20. The method of reducing insect infestation on a substrate comprising applying the insecticidal composition of claim 11 to the substrate.
